(19) United States
(12) Patent Application Publication
(10) Pub. No.: US 2004/0181590 A1
(43) Pub. Date: Sep. 16, 2004

(54) Device for switching frame and inputting command via network transmission

(76) Inventors: Wen-Shan Liou, Taipei (TW); Jwu-Sheng Hu, Taipei (TW); Chun Chi Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/387,422

(22) Filed: Mar. 14, 2003

(51) Int. Cl. G06F 15/16

(52) U.S. Cl. 709/217; 709/231

(57) ABSTRACT

The present invention provides a device for switching frame and inputting command via network transmission. The device is connected to a plurality of far-end computers via network so that a user can select and switch frame by using control commands of an input unit, or can issue control commands via network by using a far-end control program, thereby transferring the received real-time frame of a far-end computer to a display unit.

### FIELD OF THE INVENTION

The present invention relates to a device for switching frame and inputting command via network and, more particularly, to a device capable of receiving real-time frames from a remote end computer via network and outputting to a display unit.

### BACKGROUND OF THE INVENTION

Conventionally, in the situation when a display is shared by several computers (e.g. a projector is shared by several computers for briefing in a conference room), a KVM switch (Keyboard Video Mouse switch) with a keyboard or a mouse is usually used. If the user wants to display a frame, i.e. the computer screen frame, of a certain computer onto the projector screen, he will need to operate the switch keys of the KVM switch panel.

However, as the amount of computers connected to KVM switch increases, the wiring of the KVM switch will unavoidably become more complex and the number of the switch keys required will also increase accordingly. Hence, it has limit in complexity and the number of switch keys.

Moreover, if the connection cables of the computers are extended, it will cause the attenuation problem in the transmitted signals. Since the signal transmitted in the connection cables of the conventional KVM switch is analog, the signal attenuation effect will seriously influence the displaying quality of the frames. Therefore, unfortunately this conventional KVM switch also has limitation with regard to the length of its connection cables and is only suitable for short-distance applications.

Recently, some internet protocol (IP) based KVM switches (IP-based KVM switches) has been designed to send signals to and receive control signals from a remote computer via IP network. This IP based KVM switch is capable of acquiring a digitalized screen frame signal from a connected computer using an analog-to-digital converter (A/D converter) and transmit it to a remote computer via IP network. Therefore, they can be used to display the screen frame of the connected computer on the screen of the remote computer.

Besides, the user can also use a remote control program in the remote computer to send a command signal to the computer connected to the IP-based KVM switch via the IP network. Consequently, the user can control any computers connected to the IP-based KVM switch so as to change the displayed screen frame.

However, if a user needs to connect several computers located at different places (e.g. distributed in several different buildings) to a remote computer via network, each location will need to install a KVM switch in order to send frame signals and receive control signals. Nevertheless, this scheme is still uneconomical and inconvenient.

Moreover, the IP-based KVM switch digitalizes the screen frame of the connected computer by using the A/D converter, but each connected computer shall correspond to one A/D converter. Consequently, the number of the A/D converters should be added to match the number of the connected computer. The cost of the KVM switch will hence definitely rise with the number of the A/D converters added. Therefore, the IP-based KVM switch is even more costly than the conventional KVM switch.

Besides, since the screen frame of the connected computer is digitalized by the A/D converter in order to transmit over the IP network, it will experience the distortion effect caused from digitalization and degrade the quality of display.

In addition, both conventional KVM switch and IP-based KVM switch don't have the function for saving the received frames. Therefore, in the event of a user wanting to return to the previous displayed frames, he needs to switch back to the corresponding computer to acquire those frames again. It is inefficiently and sometimes it induces more unnecessary problems, such as the delay resulted from the network congestion.

Furthermore, if the KVM switch is not employed, it is necessary to manually plug in or pull out signal connection cables of the display to adapt to another computer while switching the signal cables. The action of plugging in or pulling out is not only time-consuming, but also is also likely to cause hardware damage because of erroneous plugging. Besides, sometimes the display may experience error due to mismatching of the scanning frequencies or impedances.

Therefore, as discussed above, the prior art of the KVM switch obviously still has drawbacks that can be improved. The present invention aims to resolve the drawbacks in the prior art.

### SUMMARY OF THE INVENTION

One object of the present invention is to provide a device that is capable of switching frame and inputting command via the packet based digital network transmission. Thereby, the user can switch frame by using control commands of an input unit, or issue control commands via network to use a far-end control program for transferring the real-time frames from a far-end computer to a display unit.

Another object of the present invention is to provide a device capable of switching frames and inputting command via the packet based digital network transmission by using a local hardware apparatus and several matched software programs disposed in the far-end computer. Thereby, the device of the present invention can connect several computers located at different places via packet based digital network transmission without expanding cost.

Also another object of the present invention is to provide a device capable of acquiring the original digital data of the screen frames without using A/D converter and transferring the frames via the packet based digital network transmission. Thereby, the device of the present invention can avoid distortion resulted from A/D converter and reduce the degradation of displaying quality caused by signal attenuation.

Yet another object of the present invention is to provide a device capable of storing the displayed frames of the far-end computer as a history frames and switching frame among the present real-time frame and several stored history frames.

To achieve the above objects, the present invention provides a device for switching frame and inputting command using the packet based digital network transmission. The device comprises a display unit, an input unit, a plurality of far-end computers, and a module unit. The input unit is used to input control commands which is entered by the user. The far-end computers are equipped with connection programs and/or control programs. The connection program is used to encode and packet the displayed frame of the far-end computer into pixel data. On the other hand, the control program is used to transfer control commands entered by user at the far-end computer. The module unit is connected to the far-end computers via network, and is also connected to the input unit and the display unit. This module unit is used to receive the control commands issued by the input unit or the far-end computer and then transfer the processed real-time frame of the far-end computer to the display unit, or to store the present displayed frame as a history frame; or to switch frame among the present real-time frame and several stored history frames.

The present invention also provides a device for switching frame and inputting command via the packet based digital network transmission. The device can receive control commands of an input unit to select and switch frame of a far-end computer, or transfer the real-time frame of a far-end computer via network a display unit according to the control commands, which is issued by a far-end control program. Simultaneously, the device can also store the presently displayed frame as a history frame, and can switch frames among the present real-time frame and several stored history frames. The device comprises a microprocessor connected to the input unit used as the control center, a first memory element connected to the microprocessor used for storing programs and system data, a network interface controller connected to the microprocessor and also connected to the far-end computers via network, a second memory element connected to the microprocessor and the network interface controller and used for storing the real-time pixel data transferred by the selected far-end computer via network, a frame buffer connected to the microprocessor and the second memory element and used for converting the real-time pixel data in the second memory element into frame data, and a video conversion controller connected to the microprocessor and the frame buffer and used for accessing the frame data of the frame buffer and converting the frame data into analog or digital video signals for outputting to a display unit. The frame buffer can put the frame data into the first memory element or the second memory element as a history frame.

The various objects and advantages of the present invention will be more readily understood from the following detailed description when read in conjunction with the appended drawing, in which:

### BRIEF DESCRIPTION OF THE DRAWINGS

FIG. 1 is a hardware architecture diagram of the present invention;

FIG. 2 is another hardware architecture diagram of the present invention;

FIG. 3 is a circuit block diagram of a module unit of the present invention; and

FIG. 4 is an operation flowchart of the present invention.

### DETAILED DESCRIPTION OF THE PREFERRED EMBODIMENTS

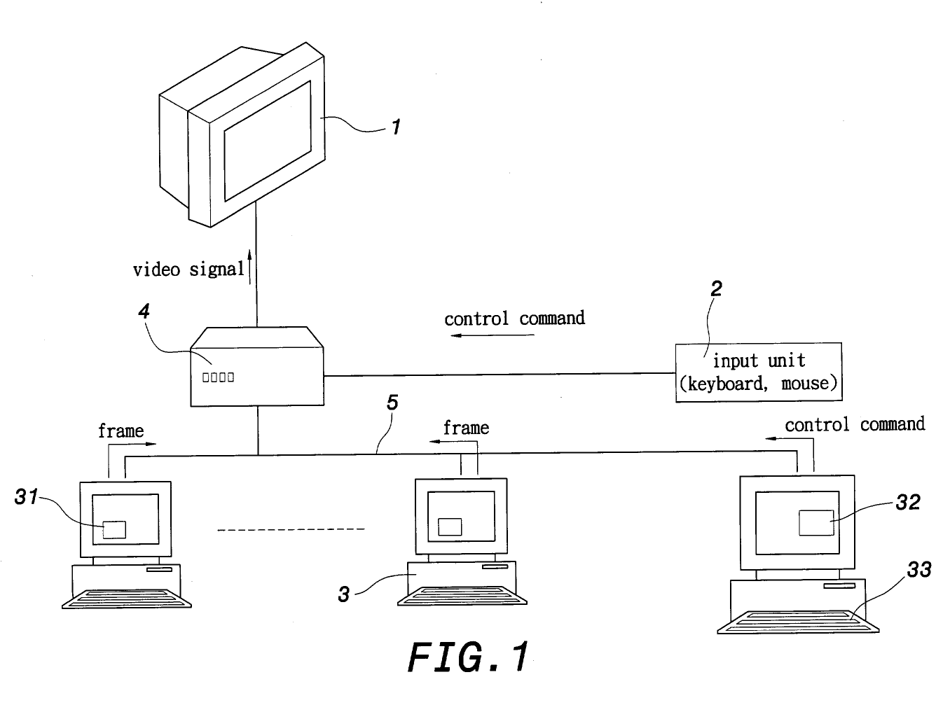

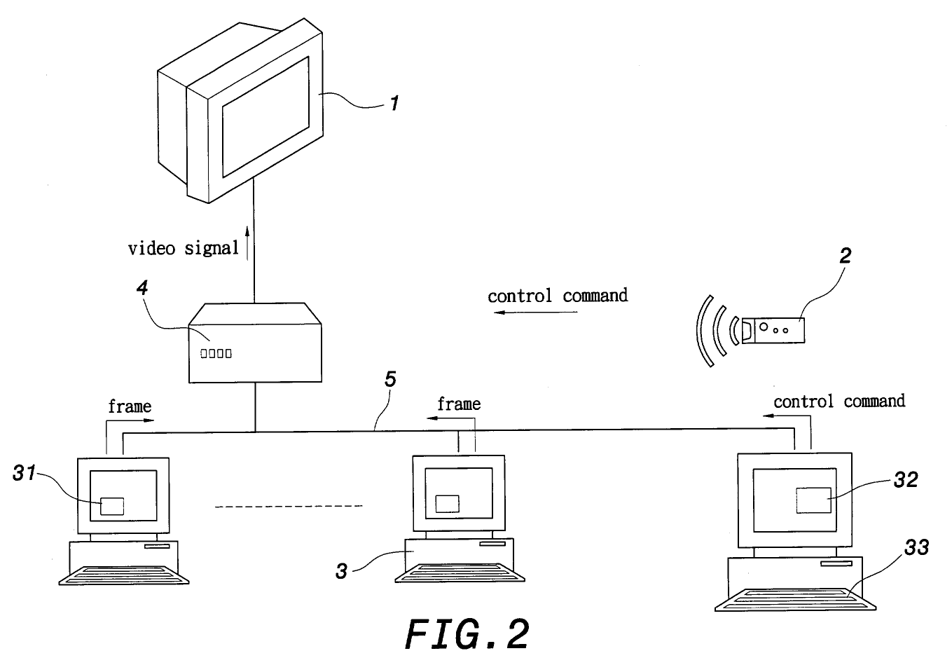

As shown in FIGS. 1 and 2, the present invention comprises a display unit 1, an input unit 2, a plurality of far-end computers 3, and a module unit 4.

The display unit 1 can be a display device like a television, a liquid crystal display (LCD), or a digital projector.

The input unit 2 can be a wired or wireless equipment like a keyboard, a remote controller, or a mouse. The input unit 2 is used to generate control commands according to actions (e.g., switching frame, selecting a far-end computer 3, standing by, or turning off) of the user.

The number of the far-end computers 3 is not limited, and can be increased or decreased according to necessity of the user. The far-end computers 3 have respective connection programs 31 and/or control programs 32. The connection program 31 is used to encode and packet the displayed frame of the far-end computer 3 into pixel data. The control program 32 is used to transfer control commands (have the same function as the above input unit 2) generated by the input end 33 (e.g., a wired or wireless equipment like a keyboard or a mouse) of the far-end computer 3 when the user operates the input end 33.

The module unit 4 is connected to the far-end computers 3 via network 5 (using the TCP/IP protocol), and is also connected to the input unit 2 and the display unit 1. The module unit 4 is used to receive the control commands issued by the input unit 2 or the input end 33 of the far-end computer 3 to switch frame, select the far-end computer 3, stand by, or turn off, and to transfer the processed real-time frame of the far-end computer 3 to the display unit 1, or to store the presently displayed frame as a history frame, or to switch frame among the present real-time frame and several stored history frames.

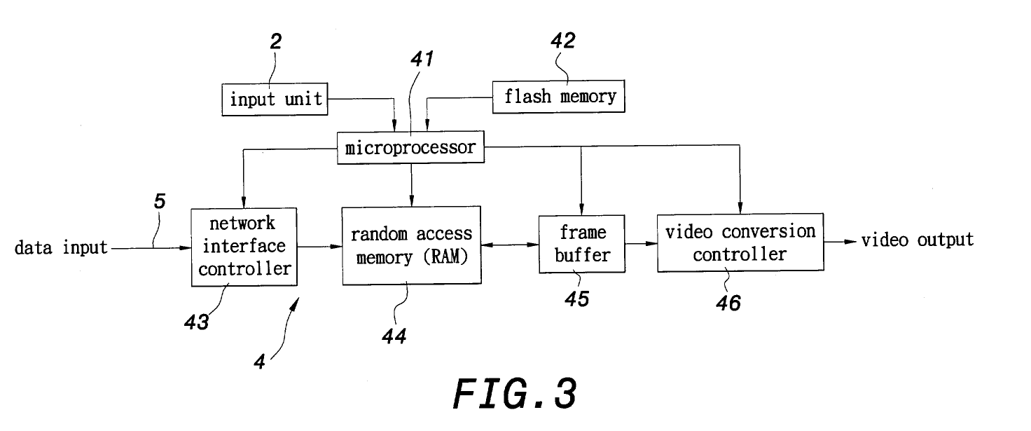

As shown in FIG. 3, the module unit 4 of the present invention comprises a microprocessor 41, a flash memory 42, a network interface controller 43, a random access memory (RAM) 44, a frame buffer 45, and a video conversion controller 46.

The microprocessor 41 is connected to the input unit 2 and used as the control center of the module unit 4.

The flash memory 42 is connected to the microprocessor 41 and used for storing programs and system data. The flash memory 42 is a non-volatile memory element.

The network interface controller 43 is connected to the microprocessor 41 and also connected to the far-end computers 3 via the network 5 to be used as a communication bridge.

The RAM 44 is connected to the microprocessor 41 and the network interface controller 42 and used to store the real-time pixel data transferred by the selected one of the far-end computers 3 via the network 5.

The frame buffer 45 is connected to the microprocessor 41 and the RAM 44 and used to convert the real-time pixel data in the RAM 44 into frame data.

The video conversion controller 46 is connected to the microprocessor 41 and the frame buffer 45 and used to read out frame data of the frame buffer 45 and convert the frame data into analog or digital video signals for outputting to the display unit 1.

Besides, the frame buffer 45 can put frame data into the flash memory 42 or the RAM 44 as a history frame through operations of the input unit 2.

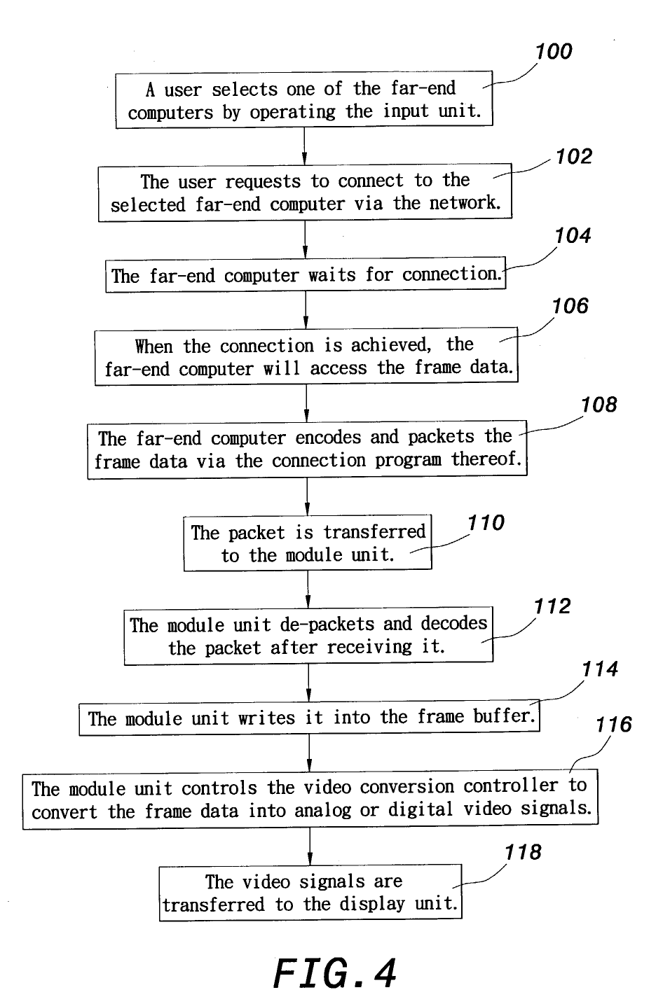

FIG. 4 shows an operation flowchart of the present invention. First, a user selects one of the far-end computers 3 by operating the input unit 2 (Step 100), and requests to connect to the selected far-end computer 3 via the network 5 (Step 102). Then, the far-end computer 3 will wait for connection Step 104). When the connection is achieved, the far-end computer 3 will access the frame data (Step 106). And, the far-end computer 3 will encode and packet the frame data via the connection program 31 thereof (Step 108). The packet is then transferred to the module unit 4 (Step 110). Next, the module unit 4 de-packets and decodes the packet after receiving the packet (Step 112), writes it into the frame buffer 45 of the module unit 4 (Step 114), and then controls the video conversion controller 46 to convert the frame data into analog or digital video signals (Step 116). Finally, the video signals are transferred to the display unit 1 for display (Step 118).

To sum up, the present invention has the following characteristics.

(1). The frame of a far-end computer can be displayed via network.

(2). Several computers can be connected together via network, and the displayed frame can be switched. Moreover, the displayed frame can be switched among the present real-time frames of the far-end computers and several history frames stored in the RAM.

(3). Operational control commands can be issued via an input unit or an input end of a far-end computer.

(4). Limit of space, wiring distance, and size of volume can be avoided.

Although the present invention has been described with reference to the preferred embodiment thereof, it will be understood that the invention is not limited to the details thereof. Various substitutions and modifications have been suggested in the foregoing description, and other will occur to those of ordinary skill in the art. For instance, the RAM or the flash memory can be replaced with memory elements having the same function. Therefore, all such substitutions and modifications are intended to be embraced within the scope of the invention as defined in the appended claims.

I claim:

1. A device for switching a frame and inputting a command via network, comprising:
a display unit;
an input unit used to input a control command;
a plurality of far-end computers each having a connection program and/or a control program, said connection program being used to encode and packet a displayed frame of into a pixel data, said control program being used to transfer a control command generated by an input end of one of the far-end computers operated by the user; and
a module unit connected to the far-end computers via network and also connected to said input unit and said display unit, said module unit being used to receive the control command issued by said input unit or said input end and transfer a processed real-time frame to said display unit, or to store the displayed frame as a history frame; or to switch a frame.

2. The device for as claimed in claim 1, wherein said display unit can be a television, a liquid crystal display, or a digital projector.

3. The device for as claimed in claim 1, wherein said input unit can be a wired or wireless equipment like a keyboard, a mouse, or a remote controller.

4. The device as claimed in claim 1, wherein said input end can be a wired or wireless equipment like a keyboard or a mouse.

5. The device as claimed in claim 1, wherein said module unit comprises:
a microprocessor connected to said input unit;
a first memory element connected to said microprocessor and used for storing programs and a system data;
a network interface controller connected to said microprocessor and also connected to said far-end computers via network;
a second memory element connected to said microprocessor and said network interface controller and used for storing the pixel data;
a frame buffer connected to said microprocessor and said second memory element and used for converting the pixel data in said second memory element into the displayed frame, said frame buffer being capable of putting the frame data into said first memory element or said second memory element as the history frame; and
a video conversion controller connected to said microprocessor and said frame buffer and used for accessing the displayed frame of said frame buffer and converting the displayed frame into an analog or a digital video signal for outputting to said display unit.

6. The device as claimed in claim 5, wherein said first memory element is a non-volatile memory.

7. The device as claimed in claim 6, wherein said non-volatile memory is a flash memory.

8. The device as claimed in claim 5, wherein said second memory element is a random access memory.

9. A device for switching a frame and inputting a command via the packet based digital network transmission, said device receiving a control command of an input unit to switch a frame of a far-end computer, or transferring the frame of said far-end computer to a display unit, said device being capable of storing the frame as a history frame, and switching the frame, said device comprising:
a microprocessor connected to said input unit and used as a control center of said module unit;
a first memory element connected to said microprocessor;
a network interface controller connected to said microprocessor and also connected to said far-end computers via network;
a second memory element connected to said microprocessor and said network interface controller and used for storing a real-time pixel data;
a frame buffer connected to said microprocessor and said second memory element and used for converting the real-time pixel data in said second memory element into the frame data, said frame buffer being capable of putting the frame data into said first memory element or said second memory element as the history frame; and
a video conversion controller connected to said microprocessor and said frame buffer and used for accessing the frame data of said frame buffer and converting he frame data into an analog or a digital video signal for outputting to said display unit.

10. The device as claimed in claim 9, wherein said input unit can be a wired or wireless equipment like a keyboard, a mouse, or a remote controller.

11. The device as claimed in claim 9, wherein said display unit can be a television, a liquid crystal display, or a digital projector.

12. The device as claimed in claim 9, wherein said first memory element is a non-volatile memory.

13. The device as claimed in claim 12, wherein said non-volatile memory is a flash memory.

14. The device as claimed in claim 9, wherein said second memory element is a random access memory.
